(19) United States
(12) Patent Application Publication
(10) Pub. No.: US 2026/0084245 A1
(43) Pub. Date: Mar. 26, 2026

(54) METHOD FOR LASER-BASED MACHINING OF AN ELONGATE WORKPIECE, AND LASER MACHINING DEVICE FOR CARRYING OUT THE METHOD

(71) Applicant: Rollomatic S.A., Le Landeron (CH)

(72) Inventors: Christian KRUMM, Cortébert (CH); Mouhamad Ali FREIDY, Neuchâtel (CH); Mike DAVOLI, Mur (CH)

(73) Assignee: Rollomatic S.A., Le Landeron (CH)

(21) Appl. No.: 19/109,703

(22) PCT Filed: Sep. 11, 2023
(86) PCT No.: PCT/EP2023/074936

§ 371 Date: Mar. 7, 2025

(30) Foreign Application Priority Data
Sep. 12, 2022 (DE) 10 2022 123 237.9

(51) Int. Cl. B23K 26/364; B23K 26/0622; B23K 26/08; B23K 26/082; B23K 101/00; B23K 101/16; B23P 15/32; B23P 15/34

(52) U.S. Cl. CPC B23K 26/364; B23K 26/0624; B23K 26/082; B23K 26/0823; B23K 26/083; B23P 15/32; B23P 15/34; B23K 2101/002; B23K 2101/16

(57) ABSTRACT

A method and a device for machining an elongated workpiece having a shaft extending in the direction of the workpiece longitudinal axis forms at least one groove with a defined groove surface on the workpiece by material removal by a laser beam directed with its beam axis onto the workpiece surface and guided along a laser path extending exclusively parallel to a groove profile curve corresponding to the intersection between the groove surface to be produced and a geometric plane that forms an angle β with the workpiece longitudinal axis, where 90°≥β≥the angle of groove inclination. The distance between the curve and the path is predetermined such that the workpiece material located in the geometric plane on the path side facing away from the curve completely sublimates or vaporizes due to the laser beam power density when the beam is guided along the path.

The invention relates to a method for laser-based machining of an elongated workpiece and a laser machining device for carrying out the method.

It is known that workpieces are machined using short, intense laser pulses. The high power density laser beam causes the material on the surface of the workpiece to heat up. The surface of the workpiece reaches such a high temperature locally that the material of the workpiece evaporates or sublimates. At high laser power densities, a plasma of electrons and ions are created from the ablated material. The removal of material is also known as laser ablation or laser vaporization. For example, material can be removed in layers. It is also possible to cut a workpiece using continuous or pulsed laser radiation. This is referred to laser cutting or laser beam cutting. The laser beam parameters must be adapted to the material to be processed and the desired processing. Laser beam parameters include wavelength and average power. If the laser beam is pulsed, the parameters also include pulse energy and pulse duration.

During laser machining, the laser beam and the workpiece are aligned in a defined manner relative to each other and, if necessary, moved in order to remove material in a desired manner within defined areas of the workpiece and to form certain contours on the surface of the workpiece. This includes, among other things, the creation of cutting edges, other edges on workpieces and clamping grooves.

A laser machining device is provided with a laser that produces a laser beam. The laser beam travels along a beam axis. The beam axis is a geometric straight line. The laser includes a laser head that directs the laser beam with its beam axis onto a workpiece in a desired manner and, if necessary, moves it over the surface of a workpiece within a predefined contour. The workpiece is arranged in an alignment and positioning device, also known as a clamping device in the case of a machine tool. This device comprises a device base, a workpiece fixing device and a workpiece movement device. The device base is stationary. It may be part of the machine base of the laser machining device. The workpiece fixing device receives the workpiece and clamps it firmly so that the position of the workpiece relative to the workpiece fixing device does not change during processing of the workpiece. The workpiece movement device ensures that the workpiece fixing device moves relative to the device base. As the laser head of the laser machining device is usually fixed in relation to the device base, the workpiece movement device also causes a relative movement between the laser head on the one hand and the workpiece fixing device on the other. Accordingly, a workpiece clamped in the workpiece fixing device is moved relative to a laser beam generated by the laser head. Alternatively, or cumulatively, the laser beam can be moved, which also results in a relative movement between the workpiece and the laser beam. The relative movement induced by the workpiece movement device allows a workpiece to be processed over its entire surface, provided that the workpiece surface is not covered by the workpiece fixing device. During processing, the workpiece and its surface are aligned at different angles to the laser beam. The laser head can be provided with a laser beam deflector, which uses optical components to deflect the laser beam in a desired manner and guide it at high speed over a surface of the workpiece. This laser beam deflector is often referred to as a laser scanner or laser scanning device. It ensures an additional relative movement of the laser beam and the workpiece. This additional relative movement is superimposed on the movement of the workpiece caused by the workpiece movement device.

To machine a workpiece, the laser beam is usually directed with its beam axis towards a workpiece to be machined so that the beam axis is perpendicular to a surface of the workpiece. Material is then removed from the surface of the workpiece in layers or sections until the workpiece has the desired shape. The workpiece can be machined in small areas, such as around a cutting edge, or in larger sections of the surface, such as along its entire side, particularly to produce an outer contour of a workpiece that extends around the circumference. This also applies when an elongated tool with a shaft and a head is to be produced from a cylindrical blank. Examples of such tools are drills, milling cutters or reamers. The shaft of such tools is fitted with the head at one end and is designed at the opposite end to be inserted into a tool holder of a machine and connected to it in a rotationally fixed manner so that the torque of the machine is transmitted to the tool. In the area of the head, the tool has one or more blades and associated cutting edges. The purpose of these is to ensure that the tool produced from the workpiece removes chips from the material to be machined at its subsequent point of use. The chips are removed through grooves that run along the outside of the shaft and extend from the head to the opposite end of the shaft. The grooves may be parallel to a longitudinal axis of the tool shaft formed by the workpiece or in form of a helix. The helix is characterised by its pitch h and its angle of rotation θ, also known as the lead angle. The pitch is the distance that the helix winds in the direction of the longitudinal axis of the workpiece during a full revolution. The thread angle or pitch angle θ is calculated from the pitch h and the radius r of the helix: θ=arctan(h/(2πr)). A groove running parallel to the longitudinal axis of the workpiece has a pitch angle θ of 90°. A circular groove running perpendicular to the longitudinal axis of the workpiece has a groove angle θ of 0°. To ensure that the chips are removed with minimum friction in the grooves where the tool made from the workpiece is used, the surface of the grooves should be smooth.

When producing grooves on the shaft of a workpiece, a particularly large amount of material has to be removed over a relatively long distance on the workpiece surface.

A method for manufacturing endodontic instruments using a laser is known from DE 199 01 777 A1. In this method, a helical groove is produced on the surface of an instrument blank using a laser by directing the beam of a highly focused Nd:YAG or CO2 laser onto the surface of the blank in a radial or secant manner and scanning it in a linear manner.

DE 10 2010 011 508 A1 also discloses a device and method for manufacturing a tool by laser machining, in which a chip groove and a cutting edge are produced on a blank. In this process, the laser beam pulses of a laser are directed onto the blank at predetermined impact points within a pulse range by means of a deflection device. A positioning device is used to perform a relative movement between the blank and the pulse surface. To create the groove, the laser beam is essentially directed radially onto the elongated workpiece. Material is removed layer by layer until the groove has the specified depth.

The disadvantage of the processes known from DE 199 01 777 A1 and DE 10 2010 011 508 A1 is that the laser beam is directed essentially perpendicular to the surface of the groove to be produced and the surface of the groove produced therefore has a high surface roughness.

A method for producing a chip groove on a rod-shaped tool is known from DE 10 2014 109 613 A1, in which a groove with a smooth surface is produced on the surface of the tool. However, this method has the disadvantage of a low removal rate. In contrast to the methods described in DE 199 01 777 A1 and DE 10 2010 011 508 A1, the laser beam in the method described in DE 10 2014 109 613 A1 is directed essentially tangentially to the surface of the groove to be produced. However, by means of a deflection device, the laser beam is guided along a pulse path that fills a pulse surface, where the pulse surface corresponds to the cross-sectional area of the material section to be removed in the groove. This beam guidance takes a long time.

The object of the invention is to provide a method for laser-based machining of an elongated workpiece and a laser machining device by means of which at least one groove with a defined groove surface is formed on the workpiece by material removal with a laser beam and the groove extends at least along a section on the outside of the shaft of the workpiece, and the material removal takes place at high removal rates and the groove produced in this way have a smooth surface with low surface roughness.

This object is solved by a method according to claim 1 and by a laser machining device according to claim 13. The method according to claim 1, characterised in that the workpiece is arranged in a workpiece fixing device of the laser machining device, so that a first end of the shaft is received in the workpiece fixing device of the laser machining device, and that material is removed with the laser beam, starting from a second end of the shaft facing away from the first end of the shaft, in the direction of the first end of the shaft or in the opposite direction, wherein the laser beam has a particular orientation and is guided along a particular laser path. The first end of the shaft end is hereinafter referred to as the first shaft end and the second end of the shaft end is hereinafter referred to as the second shaft end. A groove is formed which extends at least along a section on the outside of the shaft between a first groove end and a second groove end, wherein the first groove end is offset in the axial direction with respect to the longitudinal axis of the workpiece relative to the second groove end. The first groove end faces the first shaft end and the second groove end faces the second shaft end. To remove material, the beam axis of the laser beam is directed onto the surface of the workpiece and guided along a laser path. Throughout the material removal process, this laser path extends exclusively parallel to a groove profile curve, which corresponds to the intersection between the groove surface to be produced and a geometric plane. The geometric plane is a conceptual tool used to describe the laser path. The geometric plane, together with the point of incidence of the laser beam on the workpiece, is always at the point where the laser beam removes material from the workpiece. Therefore, as the material is removed, the geometric plane is shifted in the longitudinal direction of the workpiece to produce the groove between the first groove end and second groove end. The geometric plane is oriented at an angle β with the longitudinal axis of the workpiece, where 90°≥β≥the angle inclination of the groove. The longitudinal axis of the workpiece is a geometric straight line that extends in the longitudinal direction of the elongated workpiece through the workpiece. The geometric plane also extends through the workpiece. The point of intersection of the longitudinal axis of the workpiece and the geometric plane is inside the workpiece. As material is removed between the first end of the groove and the second end of the groove, the geometric plane, together with the groove profile curve and the laser path, moves in the axial direction relative to the longitudinal axis of the workpiece. Throughout the material removal between the first and second groove ends, the distance d between the groove profile curve and the laser beam path is fixed and does not change. The distance d between the groove profile curve and the laser beam path is set so that the material of the workpiece located in the geometric plane on the side of the laser path facing away from the groove profile curve is completely sublimated or vaporized due to the power density of the laser beam as it guided along the laser path. The distance between the laser beam and the groove profile curve therefore depends on the power density of the laser. The laser produces short high energy laser pulses. Due to the short laser pulses, there is a high energy input in the area where the laser beam hits the surface of the workpiece, so this area is heated considerably and the material of the workpiece in this area sublimates or evaporates. However, because the laser pulses are very short, the heat spreads very little throughout the workpiece. The heated area is therefore localized. This is advantageous because it prevents unwanted deformation of the workpiece under the influence of heat. The higher the power density and therefore the energy input into the workpiece surface, the more material can be removed in a given time. The expansion of the laser beam at the point of impact with the workpiece surface and/or the material of the workpiece can also play a role.

The geometric plane is aligned with the longitudinal axis of the workpiece so that the laser beam can be guided along the laser path without undesirably colliding with the workpiece. In particular, the laser beam must only strike the surface of the workpiece in the area where material is to be removed. Any interaction of the laser beam with other areas of the workpiece must be avoided. The angle β between the geometric plane and the longitudinal axis of the workpiece is set so that the laser path, as the intersection between the geometric plane and the groove surface to be produced, allows collision-free guidance of the laser beam in the specified angular range between the groove surface to be produced and the beam axis of the laser beam. In this case, the angle β is less than or equal to 90° and greater than or equal to the angle of inclination of the groove. If the groove is parallel to the longitudinal axis of the workpiece and therefore has an angle of inclination of 90°, the angle β is always 90°.

The laser beam is defined with respect to its distance d from the groove profile curve so that all material of the workpiece that is outside the laser beam with respect to the longitudinal axis of the workpiece is removed when the laser beam is guided along the laser beam. If the workpiece has a small cross-section and/or the groove is not deep, it may be sufficient to define a laser path parallel to the groove profile curve and, when the laser beam is guided along this laser path, to remove all material outside the groove profile curve so that the groove surface is created in this area. In this case, it is sufficient to move the geometric plane, the groove profile curve and the laser beam once from the first end of the groove to the second end of the groove or vice versa, at a predetermined distance d, and to remove the material with the laser to form the groove. However, if the workpiece has a large diameter and/or a deep groove, the material must be removed in layers. When the first layer is removed, the laser path is at a first position close to the outside of the workpiece, which has not yet been machined.

In this first step, the laser path is at a first distance d1 from the groove profile curve. Material removal between the first and second groove ends takes place in this first layer at this distance d1. When the material in this first layer between the first and second groove ends has been removed, in a second step the laser beam is advanced in the direction of the groove profile curve so that it is at a second position. In this second step, the laser path has a second distance d2 from the groove profile curve, whereby the second distance d2 is smaller than the first distance d1. The material removal between the first and second groove ends takes place in this second layer at this distance d2. As many layers are removed until the groove is formed. To do this, after each layer is removed, the laser path is advanced step by step in the direction of the groove profile curve until all the material outside the groove profile curve to be created has been removed.

When removing a layer from the first to the second end of the groove, the distance d between the groove profile curve and the laser beam does not change. Only when a layer has been removed from the first to the second end of the groove and not enough material has been removed to form the specified groove will the distance d change. A further layer of material is then removed from the first to the second end of the groove.

The beam axis of the laser beam is guided along the laser path so that the beam axis forms an angle δ with a tangent to the groove surface to be produced at the point of impact on the workpiece, where 1°≤δ≤10°. The beam axis is tilted in the direction opposite to the longitudinal axis of the workpiece. If the laser beam were directed tangentially, the angle δ=0°. The beam axis of the laser beam is therefore not tangential to the groove surface at the point of impact, but is slightly inclined to the tangent. By directing the laser beam at an angle to the surface of the workpiece on which material is being removed, and thus against the geometric plane, it is possible to prevent vaporized or sublimated material from being deposited on the groove surface to be created and this groove surface of the workpiece from being undesirably burned. The areas hit by the laser beam are removed in both material removal processes.

Accordingly, the groove surface produced after laser processing has a very good surface quality with low roughness. This distinguishes the process from the processes described in DE 199 01 777 A1 and DE 10 2010 011 508 A1.

As the laser beam is guided along a laser path which is exclusively parallel to the groove profile curve and at a fixed distance d from the groove profile curve, where the distance d is specified and set according to the power density, the material is removed in a much shorter time. High removal rates are therefore achieved. In contrast to DE 10 2014 109 613 A1, the laser beam is not guided in two dimensions over the entire cross-sectional area of the material section to be removed, but only along the one-dimensional laser path. This takes advantage of the fact that not only the material directly at the points of impact of the laser path is removed, but also the material outside the laser path. This is achieved by converting all of the workpiece material outside of the laser beam to a gaseous state without having to direct the laser beam over a large area across the entire area to be removed. The laser beam parallel to the groove profile curve does not define a two-dimensional surface within which the laser beam strikes the surface and material is removed only at the points of impact. The laser beam path parallel to the groove profile curve also does not define a two-dimensional surface that is moved relative to the workpiece by a relative movement between the laser beam and the workpiece to remove material over a large area. The removal rate in the process according to the invention is also significantly higher when the material is removed in several layers with different distances d1, d2, etc.

The diameter of the laser beam is set and predetermined by a laser optical system. In order to achieve a particularly high energy density at the point where the laser beam hits the surface of the workpiece, the focus of the laser beam can be adjusted to be at the surface of the workpiece. The beam axis passes through the centre of the laser beam. The laser path is defined by the movement of the beam axis. This means that the laser beam extends laterally to the laser path at the points of impact on the workpiece surface, and that material removal occurs not only directly on the laser path, but also in a section to the side of the laser path, which is determined by the diameter of the laser beam at the points of impact on the workpiece surface. In order to prevent material removal from occurring deeper in the workpiece than the specified groove surface, the laser beam is always parallel to the groove profile curve and at a minimum distance from the groove profile curve determined by the diameter of the laser beam.

According to an advantageous embodiment of the invention, the material is removed in several layers. During the removal of a first layer extending from the first groove end to the second groove end, the laser beam is guided along a first laser path parallel to the groove profile curve which has a first distance d1 to the groove profile curve during the removal of the first layer. Subsequently, during the removal of a second layer extending from the first groove end to the second groove end, the laser beam is guided along a second laser path parallel to the groove profile curve which is at a second distance d2 from the groove profile curve during the removal of the second layer. The second distance d2 is smaller than the first distance d1.

According to a further advantageous embodiment of the invention, material is removed in further layers along further laser paths with decreasing distances to the groove profile curve until the groove surface is produced.

According to a further advantageous embodiment of the invention, the material removal is carried out by means of a pulsed laser beam.

According to a further advantageous embodiment of the invention, the laser pulses have a pulse duration of at most 10 ps. The pulse duration is thus 10 ps or less. Lasers with such ultrashort laser pulses include, for example, femtosecond lasers.

According to a further advantageous embodiment of the invention, the laser beam is guided several times along the laser path. In this case, the laser beam is moved along the laser path first in one direction and then in the opposite direction. The laser beam may be guided once or several times along the same laser path for the purpose of material removal. This depends on whether a predetermined amount of material removal can be achieved with a single pass along the laser path. For multiple passes of the laser beam along the laser path, the direction in which the laser beam is guided along the laser path can be maintained or changed.

The groove is created either from the first end of the groove or from the second end of the groove. As material is removed, the geometric plane in which the groove profile curve runs is advanced from the first end of the groove to the second end of the groove or from the second end of the groove to the first end of the groove. The second end of the groove is usually located directly at the second shaft end, which is fitted with the head of the tool made from the workpiece. The first end of the groove is usually located on the shaft at a distance from the first end of the shaft. There is usually no groove in the portion of the shaft intended for fastening the tool made from the workpiece in the tool holder of a machine.

According to a further advantageous embodiment of the invention, after the laser beam has been guided once or several times along the laser path parallel to the groove profile curve from one end to the other end of the laser path, the workpiece is moved in the direction of the longitudinal axis of the workpiece by means of the workpiece movement device and the workpiece is advanced relative to the laser beam. This ensures that the workpiece is progressively laser processed in the direction of the longitudinal axis of the workpiece.

According to a further advantageous embodiment of the invention, the workpiece is rotated about the longitudinal axis of the workpiece by the workpiece moving device during laser machining. The rotation supports the single or multiple guidance of the laser beam along the laser path parallel to the groove profile curve from one end to the other end of the laser path.

According to a further advantageous embodiment of the invention, the distance between the groove profile curve and the laser path is equal to half the diameter of the laser beam at the point of incidence on the workpiece surface. Alternatively, the distance between the groove profile curve and the laser beam may be greater.

According to a further advantageous embodiment of the invention, a first movement of the laser beam along the laser path is superimposed by a second movement of the laser beam. This second movement is generated by means of an optical laser beam deflection device. This can be, for example, a laser scanner. The speed of the second movement is greater than that of the first movement. The second movement can ensure that the laser beam is moved in open or closed curves along the laser path parallel to the groove profile curve. This increases the diameter of material removal along the laser path relative to the diameter of the laser beam.

According to a further advantageous embodiment of the invention, the second movement takes place along a curve having a diameter. The distance between the groove profile curve and the laser path is equal to or greater than half the diameter of the curve of this second movement.

According to a further advantageous embodiment of the invention, the method is used to produce a cutting tool, for example a drill, a milling cutter or a reamer.

The laser machining device according to the invention is provided with a workpiece fixing device which receives and fixes the workpiece, a workpiece movement device which moves the workpiece fixing device relative to an device base, and a laser whose laser beam is directed with its geometric beam axis onto the workpiece received in the workpiece fixing device, wherein the laser machining device is designed to align the workpiece arranged in the workpiece fixing device relative to the laser beam and to move the laser beam relative to the workpiece. Further, the laser machining device has a control device which controls the laser machining device according to one of claims 1 to 12.

According to a further advantageous embodiment of the invention, the laser machining device is provided with a laser beam deflection device which produces a second movement of the laser beam. This second movement of the laser beam is superimposed on the first movement of the laser beam along the laser path parallel to the groove profile curve.

Further advantages and advantageous embodiments of the invention will be apparent from the following description, drawings and claims.

### DRAWING

The drawing shows an embodiment of the subject matter of the invention. It shows

FIG. 1 Tool made from a workpiece in perspective view,

FIG. 2 Tool according to FIG. 1 in a view on the head,

FIG. 3 Cylindrical workpiece from which the tool of FIGS. 1 and 2 is made,

FIG. 4 Workpiece according to FIG. 3 after the formation of two grooves in perspective view,

FIG. 5 Workpiece according to FIG. 4 in a view on the second end,

FIG. 6 Portion of the workpiece at the beginning of the method,

FIG. 7 Top view of the workpiece according to FIG. 6,

FIG. 8: Top view of the workpiece according to FIG. 6 after the first layer of material has been removed,

FIG. 9: Perspective view of the second shaft end of the workpiece after the first layer of material has been removed as shown in FIG. 8,

FIG. 10: Second shaft end of the workpiece according to FIG. 9 with the laser path for material removal of the second layer,

FIG. 11: Second shaft end of the workpiece in perspective view after the material removal of the second layer according to FIGS. 8 and 10,

FIG. 12: Part of the workpiece according to FIGS. 6 to 11, whereby a part of the first layer is removed in the groove,

FIGS. 13a to 13g Part of the workpiece according to FIGS. 6 to 11: material removal of a first layer in different steps,

FIGS. 14a to 14e Part of the workpiece according to FIGS. 6 to 11: material removal of a second layer in different steps,

FIG. 15: Representation of the guidance of the laser beam in a first movement along the laser path and in a superimposed second movement,

FIG. 16: First embodiment of the curve of the second movement,

FIG. 17: Second embodiment of the curve of the second movement,

FIG. 18: Workpiece in perspective view with a geometric plane forming an angle of 70° with the longitudinal axis of the workpiece,

FIG. 19: Workpiece according to FIG. 16 with material removal in the groove,

FIG. 20: Laser machining device.

### DESCRIPTION OF THE EMBODIMENT

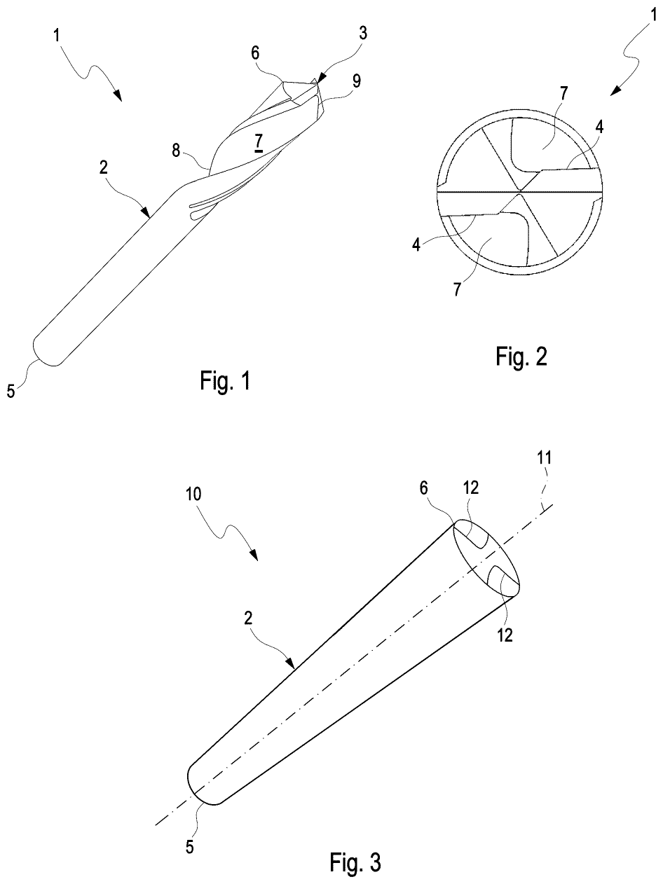

FIGS. 1 to 19 show an embodiment of a workpiece machined by the method according to the invention in various machining stages. The laser machining device 50 used to carry out the method is shown in FIG. 20. FIG. 1 shows the tool 1 made from the workpiece. It is a drill with an elongated shaft 2 and a head 3. The head 3 is provided with two cutting edges 4. The shaft 2 has a first shaft end 5 with which the workpiece 10 belonging to the tool 1 is inserted into a workpiece fixing device 51 of the laser machining device 50 and clamped. The first shaft end 5 also serves to position the tool at its later point of use, for example in a tool holder of a machine not shown in the drawing. The head 3 is located at the second shaft end 6 of the shaft 2, which is the opposite end to the first shaft end 5. Starting from the head 3 at the second shaft end 6, two grooves 7 run helically on the outside of the shaft 2 in the manner of a helix. A groove 7 is assigned to each of the two cutting edges 4. Each groove 7 has a first groove end 8 facing the first shaft end 5 of the shaft and a second groove end 9 facing the second shaft end 6 of the shaft. The second groove end 9 is located directly on the head 3 in the immediate vicinity of the cutting edges 4. The first end of the groove 8 is at a distance from the first shaft end 5 in the axial direction. In particular, the groove does not extend as far as the first shaft end 5, since a portion of the shaft 2 at the first shaft end 5 is intended for fixing the tool 1 in the tool holder of a machine.

The grooves 7 are produced by the method according to the invention on the outside of a workpiece 10 shown in FIG. 3. At the beginning of the process, the workpiece 10 is a blank in the form of a circular cylinder. This is shown in FIG. 3. The elongated workpiece 10 consists essentially of the shaft 2, since the head of the workpiece with the cutting edges shown in FIGS. 1 and 2 has not yet been produced on the workpiece 10. The shaft 2 is elongated. It extends along a longitudinal axis 11 of the workpiece. In FIG. 3, groove profile curves 12 are already drawn on the front side at the second shaft end 6 of the workpiece 10, which mark the groove surface of the grooves 7 to be produced on this front side. The surface of the workpiece 10 at the end face of the second shaft end 6 forms a geometric plane which is oriented perpendicularly to the longitudinal axis 11 of the workpiece. The groove profile curves 12 form the intersection between this geometric plane and the groove surface of the grooves to be machined. This is also shown in FIG. 6.

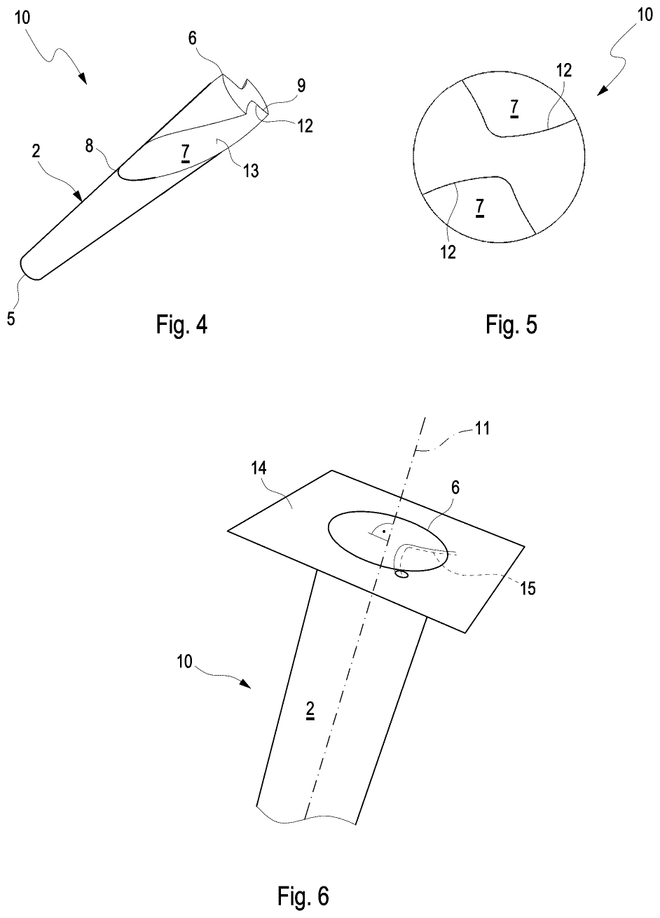

FIGS. 4 and 5 show the workpiece 10 after the method according to the invention has been carried out. The two grooves 7 are formed on the outside of the shaft 2. They extend from their first groove end 8 to their second groove end 9 on the outside of the shaft 2. Compared to the finished tool 1 as shown in FIGS. 1 and 2, only the cutting edges 4 are missing. Each of the grooves 7 has a groove surface 13. This groove surface 13 is curved in several directions. On the one hand, each of the grooves forms a depression which is curved inwards in the direction of the longitudinal axis 11 of the workpiece with respect to the remaining surface of the shaft 2. This remaining surface of the shaft 2 essentially corresponds to a cylindrical surface. On the other hand, the groove surface 13 is curved because the grooves 7 have a helical shape with respect to the longitudinal axis 11 of the workpiece. The shape of the grooves 7 can be the same from the first end of the groove 8 to the second end of the groove 9. This is the case in the example shown in the drawing. Alternatively, the shape can change from the first end of the groove to the second end of the groove. For example, the width or depth of the groove can increase or decrease from the second end of the groove to the first end of the groove. The groove profile curves 12 on the face of the workpiece 10, which can be seen in FIG. 3, correspond to the edges between the face at the second shaft end 6 and the groove surface 13 of the two grooves 7 in FIGS. 4 and 5.

FIG. 6 shows the start of material removal at the second shaft end 6 of the shaft 2 of the workpiece 10. The head of the finished tool is located at this second shaft end. Prior to the start of material removal, the front face at the second shaft end 6 of the workpiece 10 is a flat surface perpendicular to the longitudinal axis 11 of the workpiece. At the start of material removal, this flat surface corresponds to a geometric plane 14 perpendicular to the longitudinal axis 11 of the workpiece. The groove profile curve shown in FIG. 6 is not marked with the reference number 12 in FIG. 6. FIG. 3 shows the groove profile curve with reference number 12. The groove profile curve 12 corresponds to the intersection between the geometric plane 14 and the groove surface 13 to be produced according to FIG. 4. FIG. 6 also shows a laser beam path 15 parallel to the groove profile curve 13.

Since, in the example shown, the grooves 7 do not change shape from the first to the second groove end, the groove profile curve 12 is the same for any geometric plane perpendicular to the longitudinal axis 11 of the workpiece. This is true regardless of where the geometric plane intersects the workpiece longitudinal axis 11, as long as the intersection is between the first groove end and the second groove end. Since the grooves 7 have a helical shape, only the position of the groove profile curve changes from plane to plane with respect to the angle.

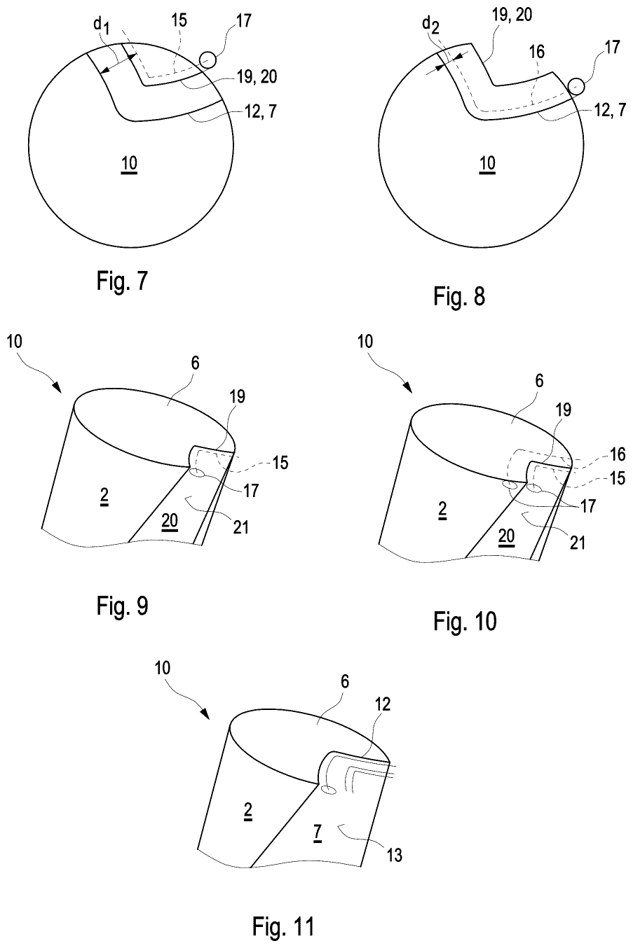

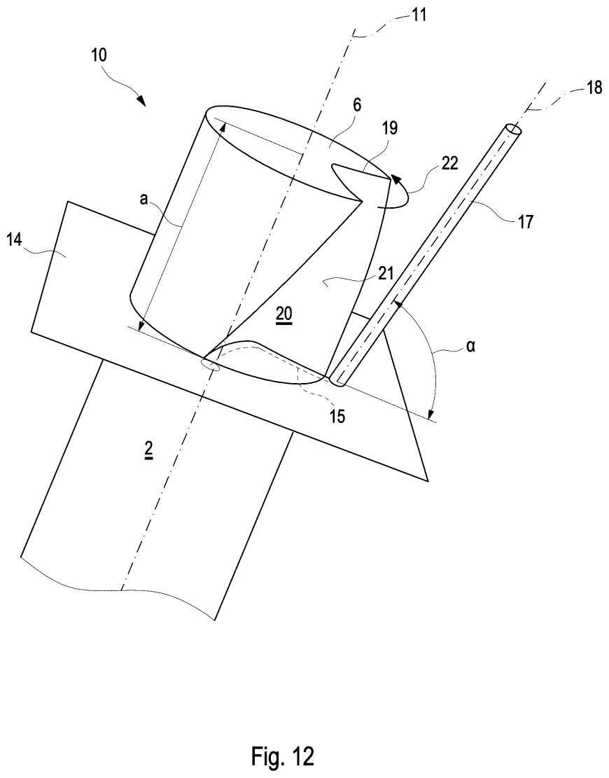

FIGS. 7 to 11 show how the laser paths 15, 16 are defined relative to the groove profile curve 12 on the workpiece 10. Since the workpiece 10 has a certain diameter, the material in the grooves must be removed in two layers. FIGS. 7 and 9 show the position of the laser path 15 during the removal of the first layer of material. It is referred to as the first laser path 15. FIGS. 8, 10 and 11 show the laser path 16 removing material for the second layer. It is referred to as the second laser path 16. The groove profile curve 12 is shown in FIGS. 7, 8 and 11. The material must be removed up to this groove profile curve 12 in order to create the groove surface 13. For the removal of the first layer according to FIGS. 7 and 9, the first laser path 15 is defined which has a first distance d1 from the groove profile curve 12. When the laser beam 17 is guided with its beam axis 18 along this first laser path 15, as shown in FIG. 12, the material located outside a first intermediate profile curve 19 is removed. FIG. 8 shows the workpiece in a top view after the laser beam has been guided along the first laser path 15 and the material outside the first intermediate profile curve 19 has been removed. FIG. 9 shows the first shaft end of the shaft 2 in perspective view after the material has been removed up to the first intermediate profile curve 19 and the material removal has been continued from the second shaft end 6 in the direction of the first shaft end 5. An intermediate groove 20 is produced, the groove surface 21 of which is parallel to the groove surface 13 of the groove 7 to be produced. The intermediate groove 20 is shallower than the final groove 7. In the FIGS. 7 and 8, the intermediate profile curve 19 coincides with the intermediate groove 20. For the removal of a second layer, a second laser path 16 is defined, which is at a distance d2 from the groove profile curve 12, where d2 is smaller than d1. When the laser beam is guided with its beam axis along the second laser path 16, the entire section of material located between the first intermediate profile curve 19 and the groove profile curve 12 is removed. When the material removal is continued from the second shaft end 6 in the direction of the first shaft end 5 and the groove 7 is created between the first groove end 8 and the second groove end 9, the groove surface 13 is created during the material removal. FIG. 11 shows a perspective view of the second shaft end 6 of the shaft 2 after the material has been removed up to the groove surface 13.

FIG. 12 shows the workpiece 10 with the laser beam 17 and the beam axis 18 during material removal. As can be seen, some of the material has already been removed from the second shaft end 6 of the shaft 2 up to a distance a from the second shaft end 6 of the shaft 2. For this purpose, the geometric plane 14 was advanced along the longitudinal axis 11 of the workpiece from the second end 6 of the shaft 2 in the direction of the first end of the shaft. In the representation according to FIG. 12, the geometric plane 14 is perpendicular to the longitudinal axis 11 of the workpiece. During material removal, the beam axis 18 of the laser beam 17 is directed so as to form an angle of between 1° and 10°. In the present case, this means that the beam axis 18 is not parallel to the longitudinal axis 11 of the workpiece and is not perpendicular to the geometric plane 14. The beam axis 18 is a geometric straight line. It forms an angle of between 1° and 10° with the longitudinal axis of the workpiece and an angle α of between 80° and 89° with the geometric plane 14. The angle a corresponds to the difference between 90° and the angle δ. The beam axis 18 is aligned with respect to the geometric plane 14 in such a way that it is inclined in the opposite direction to the longitudinal axis 11 of the workpiece. This alignment of the laser beam 17 and its beam axis 18 ensures that a particularly good surface quality of the groove surface 13 is achieved. The groove surface 13 is smooth and has a low roughness. This makes finishing of the groove surface 13 unnecessary.

In order to guide the laser beam 17 with its beam axis 18 along the first laser path 15, the workpiece 10 is rotated about the longitudinal axis 11 of the workpiece. This rotation is represented in FIG. 12 by an arrow 22. The angle by which the workpiece 10 is rotated is predetermined by the width of the groove 7 or the intermediate groove 20.

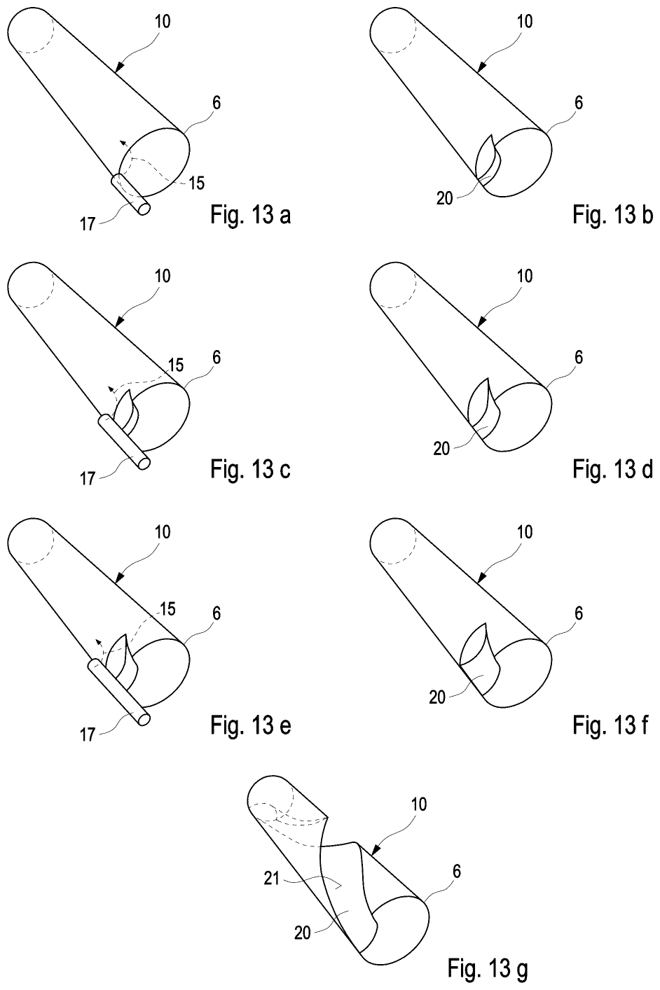

FIGS. 13a to 13g show the material removal of the first layer according to the first laser path 15 with the distance d1 between the first laser path 15 and the groove profile curve 12 in different processing steps. The groove profile curve 12 and the distance d1 are not shown in FIGS. 13a to 13g. They are shown in FIGS. 7, 8 and 11. FIG. 13a shows the workpiece 10 at the beginning of the material removal process with the laser beam 17 directed at the front side of the second shaft end 6 of the workpiece 10 and the first laser path 15. FIG. 13b shows the workpiece 10 after some of the material has already been removed and a portion of the intermediate groove 20 extending from the second portion of the intermediate groove 20 extending from the second shaft end 6 in the direction of the first shaft end. FIG. 13c shows this stage of machining with the laser beam 17 and the first laser path 15. FIG. 13d, e and f show the workpiece 10 after further removal of material from a first layer. FIG. 13g shows the section of the workpiece 10 in which the intermediate groove 20 extends between the first groove end 8 and the second groove end 9 after the first layer has been removed and the intermediate groove 20 has been created. The intermediate groove 20 has the groove surface 21.

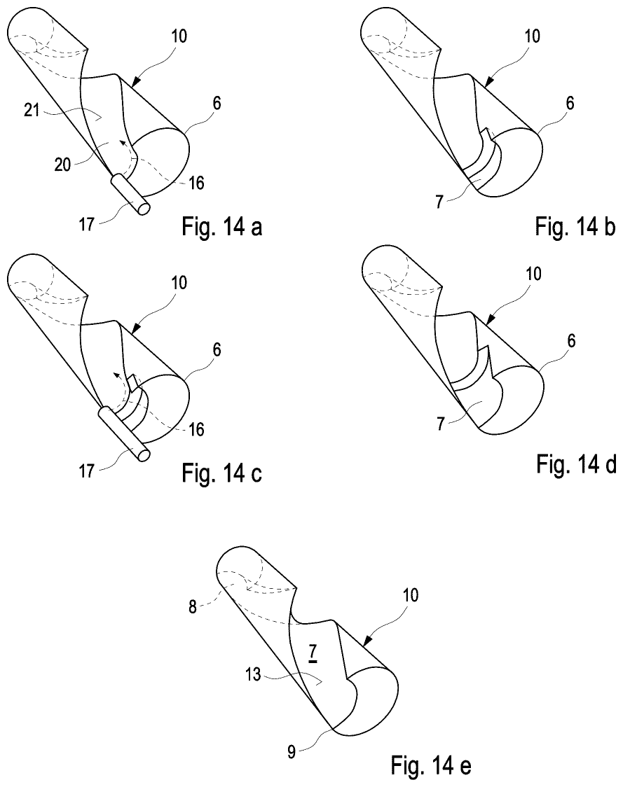

FIGS. 14a to 14e show the material removal of the second layer according to the second laser path 16 with the distance d2 between the second laser path 16 and the groove profile curve 12 at different processing stages. The groove profile curve 12 and the distance d2 are not shown in FIGS. 14a to 14e. They can be derived from FIGS. 7, 8 and 11. The workpiece 10 shown in FIG. 14a corresponds to the workpiece 10 in FIG. 13g. FIG. 14a also shows the laser beam 17 and the second laser path 16. FIGS. 14b to 14c show the workpiece 10 after some of the material of the second layer has been removed. FIG. 14e shows the part of the workpiece 10 in which the groove 7 extends between the first groove end 8 and the second groove end 9 after the second layer has been removed and the groove 7 has been created. The groove 7 has the groove surface 13.

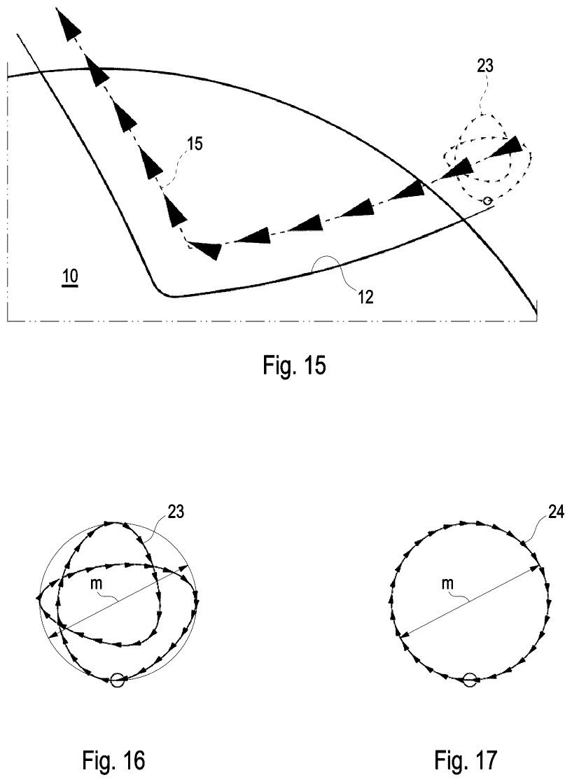

FIG. 15 shows the effect of using a laser beam deflection device 57 as shown in FIG. 20. This provides a second movement of the laser beam 17 with its beam axis 18, the second movement is superimposed on the first movement of the laser beam 17 with its beam axis 18 along the first laser path 15 parallel to the groove profile curve 12. The second movement ensures that the laser beam 17 with its beam axis 18 is guided in a loop. FIGS. 16 and 17 show as examples two possible curves 23 and 24 along which the laser beam 17 can be guided with its beam axis 18 during the second movement. Both curves are closed, whereby curve 23 is irregularly shaped and curve 24 is a circle. Both movements can be assigned a diameter m. The speed at which the second movement is performed is greater than the speed of the first movement. The second movement of the laser beam causes the material removal along the laser paths 15, 16 to take place not only in an area predetermined by the diameter of the laser beam at the point of impact on the workpiece surface, but also in an area predetermined by the diameter m of the curves 23, 24 of the second movement.

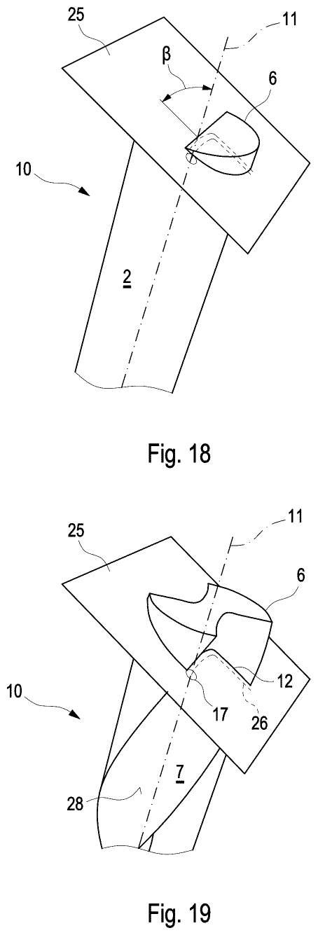

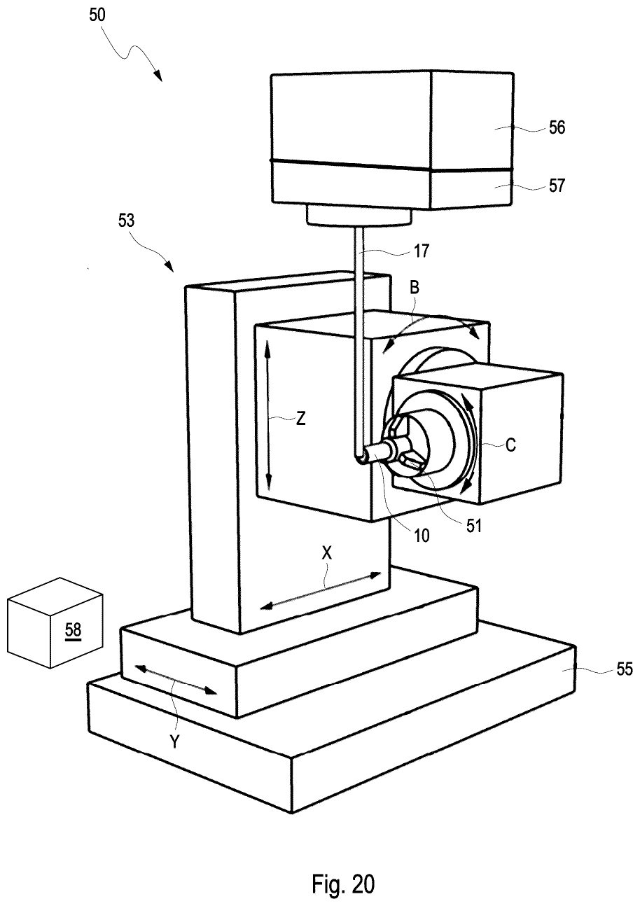

FIGS. 18 and 19 show an example of the method according to the invention in which the geometric plane 25 is not perpendicular to the longitudinal axis 11 of the workpiece, but at an angle β of 70°. In this case, too, the laser path 26 runs parallel to the groove profile curve 27 in the geometric plane 25, which results from the intersection of the groove surface 28 of the groove 7 to be produced with the geometric plane 25. Apart from the different angle between the longitudinal axis 11 of the workpiece and the geometric plane 25, the method according to FIGS. 18 and 19 corresponds to the method according to FIGS. 3 to 17.

FIG. 20 shows the laser machining device 50 for carrying out the method. The laser machining device 50 comprises a workpiece fixing device 51 which receives and fixes a workpiece 10, a workpiece movement device 53 which moves the workpiece 10 arranged in the fixing device relative to an device base 55, a laser 56 which generates the laser beam 17, and a laser beam deflection device 57 which guides the laser beam 17. In the present case, the workpiece moving device 53 has three linear axes X, Y, Z and two rotational axes B and C. The rotational axis C causes the workpiece 10 arranged in the workpiece fixing device 51 to rotate about a geometric workpiece rotational axis extending through the workpiece 10. The workpiece 10 is preferably arranged in the workpiece fixing device 51 such that the workpiece rotational axis coincides with the longitudinal axis 11 of the workpiece. The laser beam deflection device 57 moves and guides the laser beam 17 in three different directions in space. In doing so, the laser beam 17 is moved relative to the workpiece 10 along a laser path which is not shown in FIG. 18. For this purpose, the laser beam deflection device 57 comprises several mirrors which can deflect the laser beam in a targeted manner. In addition, the laser beam deflection device is provided with at least one lens which focuses the laser beam onto the surface of the workpiece 10. The mirrors and lens are not shown in the drawing. A control device 58 controls the fixing device 51, the workpiece movement device 53, the laser 56 and the laser beam deflection device 57 to carry out the process of machining the workpiece.

All of these features, individually or in any combination, may be essential to the invention.

### Reference Numbers

1 Tool
2 Shaft
3 Head
4 Cutting edge
5 First shaft end
6 Second shaft end
7 Groove
8 First groove end
9 Second groove end
10 Workpiece
11 Workpiece longitudinal axis
12 Groove profile curve
13 Groove surface
14 Geometric plane
15 First laser path
16 Second laser path
17 Laser beam
18 Beam axis
19 First intermediate profile curve
20 Intermediate groove
21 Intermediate groove surface
22 Rotation arrow
23 Laser beam deflection curve
24 Laser beam deflection curve
25 Geometric plane
26 Laser path
27 Groove profile curve
28 Groove surface
50 Laser machining device
51 Workpiece fixing device
52
53 Workpiece movement device
55 Device base
56 Laser
57 Laser beam deflector
58 Control device

1. A method for laser-based machining of an elongated workpiece (10) having a shaft (2) which extends in the direction of a longitudinal axis (11) of the workpiece,
wherein at least one groove (7) with a defined groove surface (13, 28) is formed on the workpiece (10) by material removal with a laser beam (17) and the groove (7) extends at least along a section on the outside of the shaft (2) between a first groove end (8) and a second groove end (9), wherein the first groove end (8) is offset in the axial direction with respect to the longitudinal axis (11) of the workpiece relative to the second groove end (9),
using a laser machining device (50), which comprises
a workpiece fixing device (51) which receives and fixes the workpiece (10),
a workpiece movement device (53) which moves the workpiece fixing device (51) relative to a device base (55), and
a laser (56), whose laser beam (17) is directed with its geometric beam axis (18) onto the workpiece (10) received in the workpiece fixing device (51),
wherein the laser machining device (50) is designed to align the workpiece (10) arranged in the workpiece fixing device (51) relative to the laser beam (17) and to move the laser beam (17) relative to the workpiece (10),
comprising the following method steps:
arranging the workpiece (10) in the workpiece fixing device (51) so that a first shaft end (5) of the shaft (2) is received in the workpiece fixing device (51),
removing material with the laser beam (17) starting from a second shaft end (6) of the shaft (2) facing away from the first shaft end (5) in the direction of the first shaft end (5) or in the opposite direction, wherein the groove (7) is formed between the first groove end (8), which faces the first shaft end (5), and the second groove end (9), which faces the second shaft end (6),
wherein the beam axis (18) of the laser beam (17) is directed onto the surface of the workpiece (10) and is guided along a laser path (15, 16, 26),
wherein the laser path (15, 16, 26) extends exclusively parallel to a groove profile curve (12, 27),
wherein the groove profile curve (12, 27) corresponds to the intersection between the groove surface (13, 28) to be produced and a geometric plane (14, 25) which forms an angle β with the longitudinal axis (11) of the workpiece, where 90°≥β≥the angle of inclination of the groove, and wherein the geometric plane (14, 2 5) together with the groove profile curve (12, 27) and the laser path (15, 16, 26) is displaced during the material removal between the first groove end (8) and the second groove end (9) in the axial direction relative to the workpiece longitudinal axis (11),
wherein the distance d between the groove profile curve (12, 27) and the laser beam path (15, 16, 26) is fixed and does not change during the entire material removal between the first groove end (8) and the second groove end (9),
wherein the distance d is predetermined such that the material of the workpiece (10) located in the geometrical plane (14, 25) on the side of the laser path (15, 16, 26) facing away from the groove profile curve (12, 27) is completely sublimed or vaporized when the laser beam (17) is guided along the laser path (15, 16, 26) due to the power density of the laser beam (17),
wherein the laser beam (17) is guided along the laser path (15, 16, 26) with its beam axis (18) so that the beam axis (18) forms an angle δ with a tangent to the groove surface to be produced at the point of impact on the workpiece (10), where 1°≤δ≤10°.

2. The method according to claim 1, wherein the material is removed in several layers, wherein the laser beam (17) is guided along a first laser path (15) parallel to the groove profile curve (12, 27) during the removal of a first layer extending from the first groove end (8) to the second groove end (9), wherein the laser path (15) layer has a first distance d1 from the groove profile curve (12, 27), and wherein the laser beam (17) is guided along a second laser path (16) parallel to the groove profile curve (12, 27) during the removal of a second layer extending from the first groove end (8) to the second groove end (9), wherein the laser path (16) has a second distance d2 from the groove profile curve (12, 27) during the removal of the second layer and wherein the second distance d2 is smaller than the first distance d1.

3. The method according to claim 2, wherein material is removed in further layers along further laser paths parallel to the groove profile curve (12, 27) with decreasing distances to the groove profile curve (12, 27) until the groove surface (13, 28) is produced.

4. The method according to claim 1, wherein the material removal is carried out by means of a pulsed laser beam (17).

5. The method according to claim 4, wherein the laser pulses have a pulse duration of 10 ps or less than 10 ps.

6. The method according to claim 1, wherein the laser beam (17) is guided several times along the laser path (15, 16, 26) parallel to the groove profile curve (12, 27), and wherein the laser beam (17) is moved along the laser path (15, 16, 26) first in one direction and then in the opposite direction.

7. The method according to claim 1, wherein after guiding the laser beam (17) along the laser path (15, 16, 26) parallel to the groove profile curve (12, 27) from one end to the other of this laser path (15, 16), the workpiece (10) is moved with the workpiece movement device (53) in the direction of the longitudinal axis (11) of the workpiece, and the workpiece (10) is thereby advanced relative to the laser beam (17).

8. The method according to claim 1, wherein the workpiece (10) is rotated about the longitudinal axis (11) of the workpiece by the workpiece movement device (53) during the laser machining.

9. The method according to claim 1, wherein the distance d between the groove profile curve (12, 27) and the laser path (15, 16, 26) is equal to or greater than half the diameter of the laser beam (17) at its point of impact on the workpiece surface.

10. The method according to claim 1, wherein a first movement of the laser beam (17) along the laser path (15, 16, 26) parallel to the groove profile curve (12, 27) is superimposed by a second movement of the laser beam (17) and wherein this second movement is generated by means of a laser beam deflection device (57).

11. The method according to claim 10, wherein the second movement takes place along a laser beam deflection curve (23, 24) having a diameter m, and wherein the distance d between the groove profile curve (12, 27) and the laser path (15, 16, 26) is equal or greater than half the diameter m of the laser beam deflection curve (23, 24) of this second movement.

12. The method according to claim 1, wherein a cutting tool is produced.

13. A laser machining device, which has a workpiece fixing device (51) which receives and fixes a workpiece, a workpiece movement device (53) which moves the workpiece fixing device (51) relative to a device base (55), and a laser (56) whose laser beam (17) is directed with its geometric beam axis (18) onto the workpiece (10) received in the workpiece fixing device (51), wherein the laser machining device (50) is designed to align the workpiece (10) arranged in the workpiece fixing device (51) relative to the laser beam (17), to move the laser beam (17) relative to the workpiece (10) and to remove material from the workpiece (10) with the laser beam (17), wherein the laser machining device (50) has a control device (58) which controls the laser machining device (50) according to claim 1 in such a way that the following methods steps are carried out on a workpiece (10) arranged in the workpiece fixing device (51) whose first shaft end (5) of the shaft (2) is received in the workpiece fixing device (51):
removing material with the laser beam (17) starting from a second shaft end (6) of the shaft (2) facing away from the first shaft end (5) in the direction of the first shaft end (5) or in the opposite direction, wherein the groove (7) is formed between the first groove end (8), which faces the first shaft end (5), and the second groove end (9), which faces the second shaft end (6),
wherein the beam axis (18) of the laser beam (17) is directed onto the surface of the workpiece (10) and is guided along a laser path (15, 16, 26),
wherein the laser path (15, 16, 26) extends exclusively parallel to a groove profile curve (12, 27),
wherein the groove profile curve (12, 27) corresponds to the intersection between the groove surface (13, 28) to be produced and a geometric plane (14, 25) which forms an angle β with the longitudinal axis (11) of the workpiece, where 90°≥β≥the angle of inclination of the groove, and wherein the geometric plane (14, 2 5) together with the groove profile curve (12, 27) and the laser path (15, 16, 26) is displaced during the material removal between the first groove end (8) and the second groove end (9) in the axial direction relative to the workpiece longitudinal axis (11),
wherein the distance d between the groove profile curve (12, 27) and the laser beam path (15, 16, 26) is fixed and does not change during the entire material removal between the first groove end (8) and the second groove end (9),
wherein the distance d is predetermined such that the material of the workpiece (10) located in the geometrical plane (14, 25) on the side of the laser path (15, 16, 26) facing away from the groove profile curve (12, 27) is completely sublimed or vaporized when the laser beam (17) is guided along the laser path (15, 16, 26) due to the power density of the laser beam (17),
wherein the laser beam (17) is guided along the laser path (15, 16, 26) with its beam axis (18) so that the beam axis (18) forms an angle δ with a tangent to the groove surface to be produced at the point of impact on the workpiece (10), where 1°≤δ≤10°.

14. The laser machining device according to claim 13, further comprising a laser beam deflection device (57).
